(19) United States
(12) Patent Application Publication
(10) Pub. No.: US 2026/0365123 A1
(43) Pub. Date: Nov. 19, 2026

(54) GROMMET AND WIRE HARNESS

(71) Applicant: YAZAKI CORPORATION, Tokyo (JP)

(72) Inventor: Suguru Nishino, Susono-shi (JP)

(21) Appl. No.: 19/676,831

(22) Filed: May 14, 2026

(30) Foreign Application Priority Data
May 14, 2025 (JP) 2025-081174

(51) Int. Cl. B60R 16/02; H02G 3/00; H02G 3/04

(52) U.S. Cl. CPC B60R 16/0222; H02G 3/0468; H02G 3/263

(57) ABSTRACT

A grommet includes a grommet main body that is fitted into a through hole. A panel fitting portion that is fitted with the attachment panel is provided at an outer peripheral edge of the grommet main body. The grommet main body and the panel fitting portion contain a thermoplastic elastomer as a main component. The panel fitting portion includes: a first abutting portion that abuts against one side surface of a peripheral edge of the through hole, a second abutting portion that abuts against the other side surface of the peripheral edge of the through hole, and a fitting groove that is fitted with the attachment panel. In the fitting groove, a curvature radius of a corner portion formed between an outer peripheral surface of the grommet main body and an inner side surface of the first abutting portion is 0.5 mm or more. A wire harness includes the grommet.

### CROSS-REFERENCE TO RELATED APPLICATIONS

The present application is based on, and claims priority from the prior Japanese Patent Application No. 2025-081174, filed on May 14, 2025, the entire contents of which are incorporated herein by reference.

### TECHNICAL FIELD

The present disclosure relates to a grommet and a wire harness.

### BACKGROUND

In the related art, when an electric wire passes through a through hole formed in advance in a plate material, there is provided a grommet that is attached to a peripheral edge of the through hole in order to protect the electric wire from the peripheral edge of the through hole. JP 2001-145237 A discloses a grommet including a small-diameter tubular portion that is formed of rubber or an elastomer and is configured so that a wire harness is inserted therethrough in a tightly fitted state, a large-diameter tubular portion that is continuous in a conical tubular shape from one end of the small-diameter tubular portion, and a recess portion for vehicle-body locking that is provided annularly on an outer peripheral surface of the large-diameter tubular portion. Further, J P 2024-68265 A describes that ethylene-propylene-diene rubber (EPDM), which is a thermosetting elastomer, is used as a main component of a grommet.

### SUMMARY OF THE INVENTION

In recent years, in order to expand a range of selection for a material of a grommet, a thermoplastic elastomer having flexibility higher than that of a thermosetting elastomer has attracted attention. However, the thermoplastic elastomer has strength lower than that of the thermosetting elastomer. Therefore, in a case where the thermoplastic elastomer is applied to the related-art grommet, when the grommet is fitted into a through hole of a plate material, a load is applied to a fitting part of the grommet. Consequently, there is a possibility that a crack is generated in the grommet.

The present disclosure has been made in view of such problems in the related art. Further, an object of the present disclosure is to provide a grommet capable of suppressing generation of a crack at a time of fitting even when a thermoplastic elastomer is used, and a wire harness using the grommet.

A connector according to a first aspect of an embodiment includes a grommet main body that is fitted into a through hole provided in an attachment panel. A panel fitting portion is provided integrally with the grommet main body, the panel fitting portion being provided at an outer peripheral edge of the grommet main body, extending to a radially outer side of the grommet main body, and being fitted with the attachment panel. The grommet main body and the panel fitting portion contain a thermoplastic elastomer as a main component. The panel fitting portion includes a first abutting portion that is formed annularly and abuts against one side surface of a peripheral edge of the through hole, a second abutting portion that is formed annularly, faces the first abutting portion, and abuts against the other side surface of the peripheral edge of the through hole, and a fitting groove that is formed annularly, is provided between the first abutting portion and the second abutting portion, and is fitted with the attachment panel. In the fitting groove, a curvature radius of a corner portion formed between an outer peripheral surface of the grommet main body and an inner side surface of the first abutting portion is 0.5 mm or more.

A wire harness according to a second aspect of an embodiment includes a wiring material having electroconductivity, and the grommet through which the wiring material is inserted.

According to the present disclosure, it is possible to provide a grommet capable of suppressing generation of a crack at a time of fitting even when a thermoplastic elastomer is used, and a wire harness using the grommet.

### BRIEF DESCRIPTION OF DRAWINGS

FIG. 1 is a perspective view illustrating a grommet according to the present embodiment and a wiring material through which the grommet is inserted.

FIG. 2 is a side view illustrating the grommet according to the present embodiment.

FIG. 3 is a cross-sectional view illustrating the grommet according to the present embodiment.

FIG. 4 is an enlarged cross-sectional view illustrating a panel fitting portion of the grommet according to the present embodiment.

FIG. 5 is an enlarged cross-sectional view illustrating a state where an attachment panel is fitted with the panel fitting portion of the grommet according to the present embodiment.

### DETAILED DESCRIPTION OF THE INVENTION

With reference to the drawings, a grommet and a wire harness according to the present embodiment are described below in detail. Note that the dimensional ratios in the drawings are exaggerated for explanatory purposes, and may differ from the actual ratios.

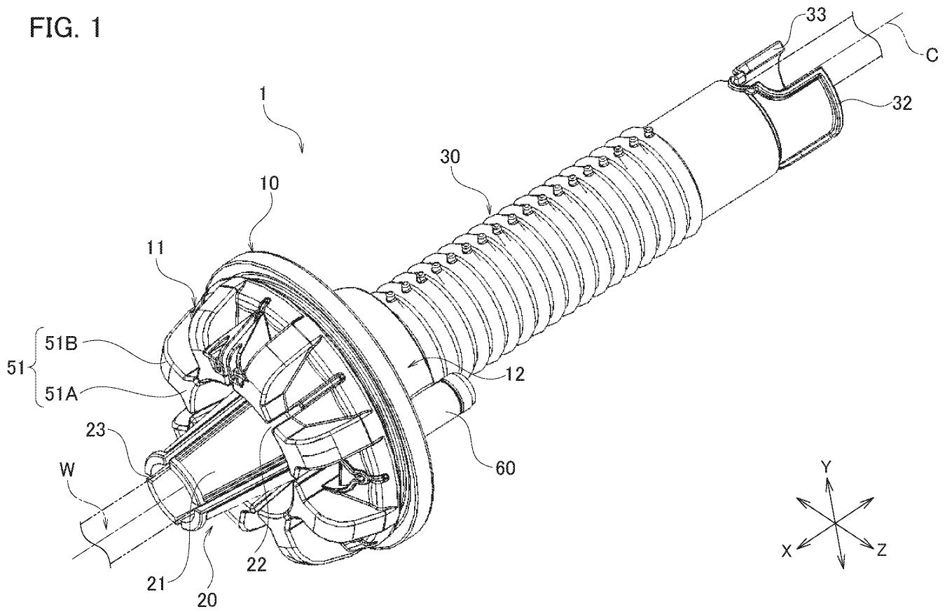

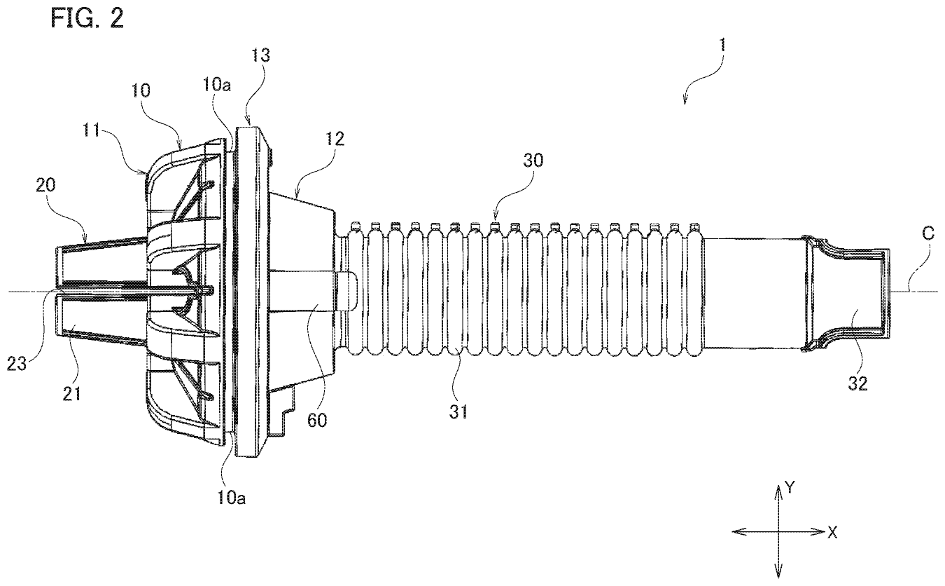

As illustrated in FIG. 1 and FIG. 2, a grommet 1 of the present embodiment is incorporated into a wire harness routed in a vehicle or the like. The wire harness is an assembled component in which a plurality of wiring materials W used for power supply and signal communication are bundled to establish connection between respective devices mounted in the vehicle, and the plurality of wiring materials W are connected to the respective devices by connectors or the like. The wire harness includes the wiring material W having electroconductivity and the grommet 1 through which the wiring material W is inserted. The wire harness may further include various constituent components such as an exterior member including a corrugated tube, a resin tape, and a protector, an electrical junction box, and a fixture. The wiring material W is configured by at least one selected from the group consisting of a metal rod, an electric wire, and a wire bundle.

The grommet 1 is applied to a through hole 101 when the wiring material W is routed across two spaces partitioned via an attachment panel 100 serving as an attached member. The attachment panel 100 is, for example, a metal plate forming a vehicle body or the like, and the through hole 101 passes through the attachment panel 100 along a plate thickness direction. The two spaces partitioned with the attachment panel 100 as a boundary are typically an interior space (for example, a passenger compartment) and an exterior space (for example, an engine room). In this case, the attachment panel 100 is a dash panel. Further, the grommet 1 is assembled to the through hole 101 in a state where the wiring material W is inserted therethrough and the grommet 1 is externally mounted around the wiring material W, thereby protecting the wiring material W passing through the through hole 101 and waterproofing the through hole 101. Note that the grommet 1 also has functions such as dustproofing and sound insulation in addition to waterproofing of the through hole 101.

Note that, in the following description, a direction X in the drawings is referred to as an “axial direction X”, a direction Y is referred to as a “width direction Y”, and a direction Z is referred to as a “height direction Z”. The axial direction X, the width direction Y, and the height direction Z are orthogonal to one another. The axial direction X corresponds to the plate thickness direction of the attachment panel 100, and corresponds to the insertion direction in which the wiring material W and the grommet 1 are inserted through the through hole 101. The width direction Y and the height direction Z correspond to an extending direction of the attachment panel 100. Further, a center axis C passing through the center of the through hole 101 is orthogonal to the plate surface of the attachment panel 100, and extends along the axial direction X. A direction orthogonal to the center axis C is referred to as a radial direction, a side away from the center axis C is referred to as a radially outer side, and a side close to the center axis C is referred to as a radially inner side.

The grommet 1 of the present embodiment is a sealing member through which the wiring material W is inserted along the axial direction X and that is capable of stopping water between the grommet 1 and the through hole 101 of the attachment panel 100. The grommet 1 includes a grommet main body 10, a first tubular portion 20, and a second tubular portion 30, and those are integrally formed as an elastic body. In the grommet 1, internal spaces of the grommet main body 10, the first tubular portion 20, and the second tubular portion 30 function as an insertion space 40. The insertion space 40 is a space through which the wiring material W is inserted, and is continuous along the axial direction X across the first tubular portion 20, the grommet main body 10, and the second tubular portion 30.

The grommet main body 10 is a part that is fitted into the through hole 101 to stop water at the through hole 101 and through which the wiring material W is inserted. The grommet main body 10 includes a first partition wall portion 11, a second partition wall portion 12, and a panel fitting portion 13.

The first partition wall portion 11 and the second partition wall portion 12 are integrated with each other while facing each other along the axial direction X. The panel fitting portion 13 is an outer peripheral portion provided annularly at an end portion of a joining part between the first partition wall portion 11 and the second partition wall portion 12. The first partition wall portion 11 and the second partition wall portion 12 protrude toward the radially inner side of the panel fitting portion 13, and are respectively arranged on one side and the other side of the panel fitting portion 13 in the axial direction X so as to close the annular shape of the panel fitting portion 13. The first partition wall portion 11 and the second partition wall portion 12 are integrally formed with the panel fitting portion 13, and are formed as a hollow dome shape as a whole.

The panel fitting portion 13 is positioned on the radially outer side with respect to the first partition wall portion 11 and the second partition wall portion 12. The panel fitting portion 13 is a sealing member that is inserted in the through hole 101 of the attachment panel 100 to stop water between the panel fitting portion 13 and the through hole 101. The panel fitting portion 13 is formed annularly about the center axis C in conformity with the annular shape of the through hole 101. In the present embodiment, the through hole 101 is formed in a circular shape, and the panel fitting portion 13 is also formed in a circular shape in conformity therewith.

A surface of the first partition wall portion 11, which is opposite to a surface on the second partition wall portion 12 side in the axial direction X, is connected to the first tubular portion 20. A surface of the second partition wall portion 12, which is opposite to a surface on the first partition wall portion 11 side in the axial direction X, is connected to the second tubular portion 30. As illustrated in FIG. 1 and FIG. 2, the first tubular portion 20 and the second tubular portion 30 are formed integrally with the grommet main body 10 in a tubular shape, and the wiring material W is inserted therethrough along the axial direction X.

As illustrated in FIG. 1, the first partition wall portion 11 includes a protruding portion 51. The protruding portion 51 includes an annular protrusion portion 51A that is formed annularly about the center axis C so as to surround a base end portion 22 of the first tubular portion 20, and a plurality of radially protruding portions 51B that extend from the annular protrusion portion 51A to the radially outer side and are positioned radially about the center axis C. The annular protrusion portion 51A protrudes to the outside (to a side opposite to the second partition wall portion 12 in the axial direction X) at the first partition wall portion 11. The radially protruding portions 51B are located at eight positions at an equal interval in a circumferential direction. The grommet 1 improves strength of the first partition wall portion 11, and suppresses deformation thereof by the protruding portion 51. For example, when the wiring material W is inclined in a direction intersecting with the axial direction X, deformation of the grommet main body 10 is suppressed by the protruding portion 51. Further, by suppressing deformation of the first partition wall portion 11 in the radial direction by the protruding portion 51, transmission of the deformation to the panel fitting portion 13 is suppressed, and watertightness of the panel fitting portion 13 is maintained.

The first tubular portion 20 is formed so as to protrude from the first partition wall portion 11 to the other side (a side opposite to the second partition wall portion 12) along the axial direction X. The first tubular portion 20 is formed in a cylindrical shape about the center axis C, and extends along the axial direction X. The first tubular portion 20 is formed in a cylindrical shape having a smaller diameter than the first partition wall portion 11. On the other side of the first tubular portion 20 in the axial direction X, a distal end portion 21 is opened. On the one side of the first tubular portion 20, a proximal end portion 22 is integrally connected to the first partition wall portion 11. The first tubular portion 20 is gradually reduced in diameter from the proximal end portion 22 toward the distal end portion 21.

Further, the first tubular portion 20 is formed with notches 23 at a distal end where the distal end portion 21 is opened. Each of the notches 23 is a part that has a predetermined width in the circumferential direction about the center axis C and is cut out from an opening end of the distal end portion 21 along the axial direction X. In the present embodiment, four notches 23 are formed at an equal interval. When the wiring material W is inserted through an inside of the distal end portion 21 of the first tubular portion 20, and a tape or the like is wound around an outer periphery of the distal end portion 21, the notches 23 are elastically deformed to bring an inner surface of the distal end portion 21 into close contact with an outer surface of the wiring material W, thereby sealing the entire circumference of the wiring material W.

The second tubular portion 30 is formed to protrude from the second partition wall portion 12 to the one side (a side opposite to the first partition wall portion 11) along the axial direction X. The second tubular portion 30 is formed in a cylindrical shape about the center axis C, and extends along the axial direction X. The second tubular portion 30 is formed in a cylindrical shape having a smaller diameter than the second partition wall portion 12. On the one side of the second tubular portion 30 in the axial direction X, a distal end is opened. A base end thereof on the other side is integrally connected to the second partition wall portion 12. The second tubular portion 30 is formed with a bellows portion 31 at an intermediate portion in the extending direction. The bellows portion 31 is formed by forming a part of the second tubular portion 30 in the axial direction X into a bellows shape. In other words, the bellows portion 31 is formed in a shape in which a part of the second tubular portion 30 in the axial direction X alternately changes in a direction in which a diameter is increased and a direction in which a diameter is reduced as approaching the one side in the axial direction X. Due to the bellows portion 31, the second tubular portion 30 can be easily bent at a position of the bellows portion 31 in accordance with bending of the inserted wiring material W.

Further, the second tubular portion 30 is formed with notches 33 at a distal end portion 32. Each of the notches 33 is a part that has a predetermined with in the circumferential direction about the center axis C and is cut out from an opening end of the distal end portion 32 along the axial direction X. The notches 33 are formed at two positions that are point-symmetric with respect to the second tubular portion 30 about the center axis C. When the wiring material W is inserted through an inside of the second tubular portion 30, and a tape or the like is wound around an outer periphery of the distal end portion 32 of the second tubular portion 30, the notches 33 are elastically deformed to bring an inner surface of the distal end portion 32 into close contact with the outer surface of the wiring material W, thereby sealing the entire circumference of the wiring material W.

As illustrated in FIG. 1 and FIG. 2, the grommet main body 10 includes tubular members 60. Each of the tubular members 60 is formed to protrude from the first partition wall portion 11 to the one side along the axial direction X. The tubular member 60 is formed in a cylindrical shape, and extends along the axial direction X. The tubular member 60 is formed in a cylindrical shape having a smaller diameter than the first tubular portion 20 and the second tubular portion 30. A distal end portion of the tubular member 60 on one side in the axial direction X is closed, and a base end portion thereof on the other side is connected to the first partition wall portion 11. In the present embodiment, the tubular members 60 are located at two positions. The tubular members 60 at the two positions are located at every 180 degrees in the circumferential direction with the center axis C interposed therebetween. For example, when a pipe for carrying washer fluid is passed in the axial direction X after the grommet 1 and the wiring material W are attached to the through hole 101 of the attachment panel 100, the tubular member 60 is passed through.

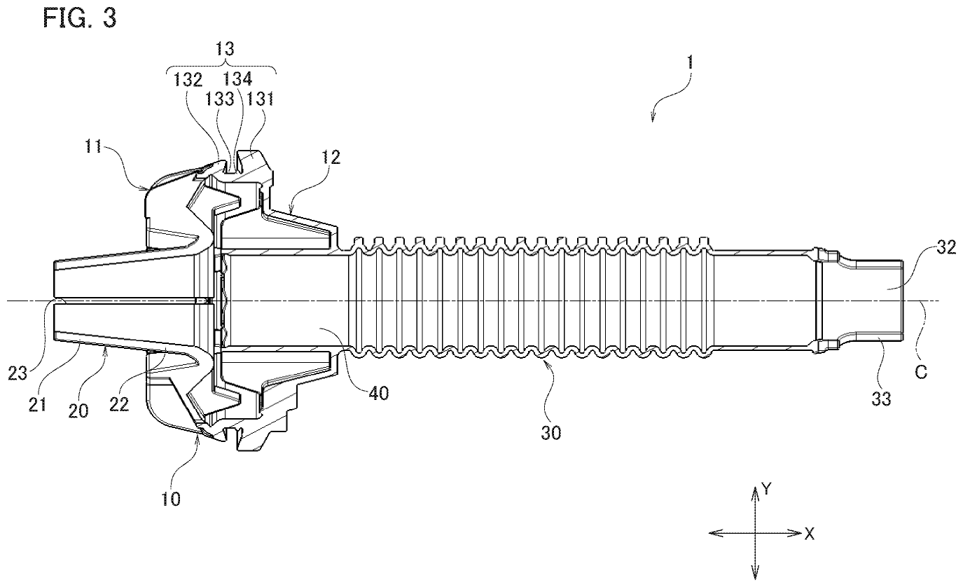

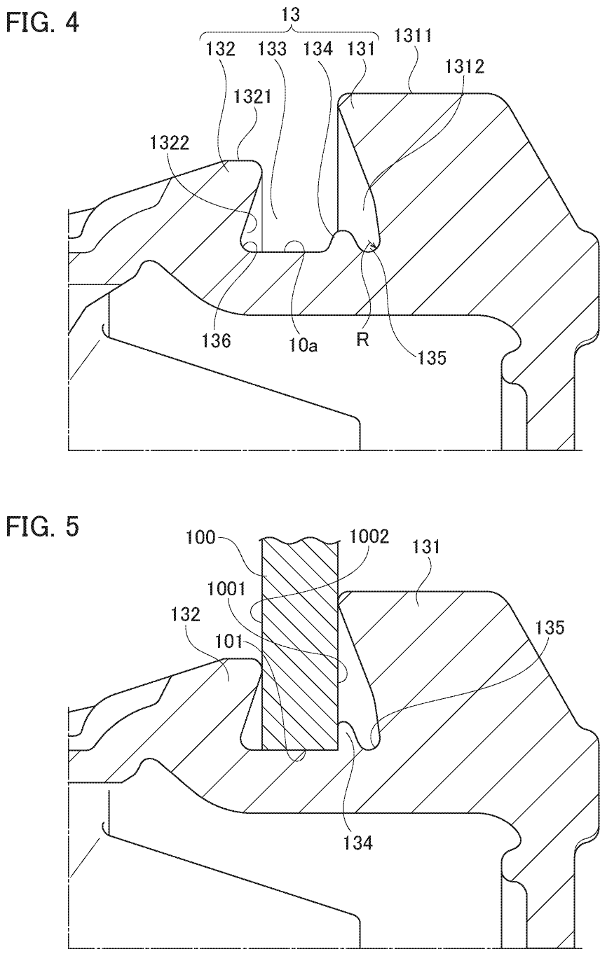

Here, the panel fitting portion 13 is described further in detail. As illustrated in FIG. 3 to FIG. 5, the panel fitting portion 13 includes a first abutting portion 131, a second abutting portion 132, and a fitting groove 133. FIG. 4 illustrates a state before the panel fitting portion 13 is inserted in the through hole 101 of the attachment panel 100, and FIG. 5 illustrates a state after the panel fitting portion 13 is inserted in the through hole 101 of the attachment panel 100.

The first abutting portion 131 is provided to abut against one side surface 1001 of the peripheral edge of the through hole 101 in a state where the panel fitting portion 13 is inserted in the through hole 101 of the attachment panel 100. The one side surface 1001 of the peripheral edge of the through hole 101 is, for example, a surface on the exterior space side of the spaces partitioned with the attachment panel 100 as a boundary. The first abutting portion 131 extends to the radially outer side of the grommet main body 10. And is formed to be inclined in the axial direction X so that the distal end is oriented to the one side surface 1001 of the peripheral edge of the through hole 101. The first abutting portion 131 is formed annularly along an outer peripheral surface 10a of the grommet main body 10 and the through hole 101.

The second abutting portion 132 is provided to abut against the other side surface 1002 of the peripheral edge of the through hole 101 in a state where the panel fitting portion 13 is inserted in the through hole 101 of the attachment panel 100. The other side surface 1002 of the peripheral edge of the through hole 101 is, for example, a surface on the interior space side of the spaces partitioned with the attachment panel 100 as a boundary. The second abutting portion 132 extends to the radially outer side of the grommet main body 10, and is formed to be inclined in the axial direction X so that the distal end is oriented to the other side surface 1002 of the peripheral edge of the through hole 101. The second abutting portion 132 is formed annularly along the outer peripheral surface 10a of the grommet main body 10 and the through hole 101.

Note that the first abutting portion 131 and the second abutting portion 132 are provided so as to face each other across the attachment panel 100. Further, an outer peripheral edge 1311 of the first abutting portion 131 is positioned on the radially outer side with respect to an outer peripheral edge 1321 of the second abutting portion 132.

The fitting groove 133 is a recess provided between the first abutting portion 131 and the second abutting portion 132, and the peripheral edge of the through hole 101 of the attachment panel 100 is inserted therein. Further, the fitting groove 133 is formed annularly along the through hole 101.

At a far portion of the fitting groove 133 on the radially inner side, a projection 134 is formed. The projection 134 extends to the radially outer side of the grommet main body 10, and is formed annularly along the outer peripheral surface 10a of the grommet main body 10 and the through hole 101. As illustrated in FIG. 5, in a state where the peripheral edge of the through hole 101 is inserted in the fitting groove 133, the projection 134 abuts against the peripheral end of the through hole 101, is elastically deformed, and supports the peripheral end of the through hole 101.

Here, as illustrated in FIG. 4 and FIG. 5, in the fitting groove 133, the outer peripheral surface 10a of the grommet main body 10 extends substantially in parallel to the axial direction X. Further, an inner side surface 1312 of the first abutting portion 131 extends to the radially outer side of the grommet main body 10, and the inner side surface 1312 is slightly inclined with respect to the width direction Y and the height direction Z so that the distal end is oriented to the one side surface 1001 of the peripheral edge of the through hole 101. A first corner portion 135 that is bent is formed between the outer peripheral surface 10a of the grommet main body 10 and the inner side surface 1312 of the first abutting portion 131. In the cross-section along the axial direction X, the first corner portion 135 has a substantially arc shape. Further, the first corner portion 135 is formed annularly along the outer peripheral surface 10a of the grommet main body 10.

Further, an inner side surface 1322 of the second abutting portion 132 extends to the radially outer side of the grommet main body 10, and the inner side surface 1322 is slightly inclined with respect to the width direction Y and the height direction Z so that the distal end is oriented to the other side surface 1002 of the peripheral edge of the through hole 101. A second corner portion 136 that is bent is formed between the outer peripheral surface 10a of the grommet main body 10 and the inner side surface 1322 of the second abutting portion 132. In the cross-section along the axial direction X, the second corner portion 136 has a substantially arc shape. Further, the second corner portion 136 is formed annularly along the outer peripheral surface 10a of the grommet main body 10.

After the wiring material W is inserted through the insertion space 40, which is an internal space of the grommet main body 10, the first tubular portion 20, and the second tubular portion 30, the grommet 1 configured as described above is inserted through the through hole 101 together with a terminal end of the wiring material W from the second tubular portion 30 side. The grommet 1 is assembled to the attachment panel 100 by inserting the peripheral edge of the through hole 101 in the fitting groove 133 of the panel fitting portion 13 of the grommet main body 10, holding the peripheral end of the through hole 101 by the projection 134 of the fitting groove 133, and fitting the grommet main body 10 into the through hole 101. In this state, the panel fitting portion 13 comes into close contact with the peripheral edge of the through hole 101 by sandwiching the peripheral edge of the through hole 101 between the first abutting portion 131 and the second abutting portion 132 that are elastically deformed by abutting against the peripheral edge of the through hole 101. With this configuration, the grommet 1 can seal the entire peripheral edge of the through hole 101. Note that the grommet 1 may stop water at the opening of the first tubular portion 20 by winding a tape around the outer periphery of the distal end portion 21 of the first tubular portion 20. Similarly, water may be stopped at the opening of the second tubular portion 30 by winding a tape around the outer periphery of the distal end portion 32 of the second tubular portion 30. In this manner, by fitting the grommet main body 10 into the through hole 101 formed in the attachment panel 100, water is stopped at the through hole 101, and the wiring material W is inserted through the inside of the grommet 1.

Here, the grommet 1 of the present embodiment contains a thermoplastic elastomer as a main component. Specifically, in the grommet 1, at least the grommet main body 10 and the panel fitting portion 13 contain the thermoplastic elastomer as a main component. Further, in the grommet 1, in addition to the grommet main body 10 and the panel fitting portion 13, the first tubular portion 20 and the second tubular portion 30 may contain the thermoplastic elastomer as a main component. Here, the “main component” means a material having a largest content by mass among materials contained in the grommet.

In the fitting groove 133 of the panel fitting portion 13 of the grommet 1, the first corner portion 135 is formed between the outer peripheral surface 10a of the grommet main body 10 and the inner side surface 1312 of the first abutting portion 131. The first corner portion 135 is formed annularly along the outer peripheral surface 10a of the grommet main body 10, and has a substantially arc shape in the cross-section along the axial direction X. Further, in the cross-section along the axial direction X, a curvature radius R of the first corner portion 135 is 0.5 mm or more.

When the grommet 1 is assembled to the through hole 101 of the attachment panel 100, a load is applied to the panel fitting portion 13 in order to enhance watertightness. However, a thermoplastic elastomer has higher flexibility than a thermosetting elastomer, but has lower strength. Thus, in the present embodiment, in order to reduce the load applied to the panel fitting portion 13, the first corner portion 135 of the panel fitting portion 13 is formed in a substantially arc shape, and the curvature radius R is increased to 0.5 mm or more. As a result, the load applied to the panel fitting portion 13 is dispersed. Thus, a possibility that a crack is generated in the panel fitting portion 13 is reduced, and the functions such as watertightness, dustproofing, and sound insulation can be maintained over a long period.

Note that, at the panel fitting portion 13 of the grommet 1, the curvature radius R of the first corner portion 135 in the cross-section along the axial direction X is preferably 0.5 mm to 1.0 mm. When the curvature radius R of the first corner portion 135 falls within this range, a possibility that a crack is generated in the panel fitting portion 13, in particular, in the first corner portion 135 can be reduced more.

As described above, the grommet 1 is characterized in that the curvature radius R of the first corner portion 135 between the outer peripheral surface 10a of the grommet main body 10 and the inner side surface 1312 of the first abutting portion 131 is 0.5 mm or more. Thus, the curvature radius R of the second corner portion 136 interposed between the outer peripheral surface 10a of the grommet main body 10 and the inner side surface 1322 of the second abutting portion 132 is not particularly limited. However, in view of dispersing the load applied to the panel fitting portion 13 and reducing a possibility of generation of a crack, the curvature radius R of the second corner portion 136 in the cross-section along the axial direction X may be 0.5 mm or more. Further, the curvature radius R of the second corner portion 136 may be 0.5 mm to 1.0 mm.

The thermoplastic elastomer applied in the grommet 1 is composed of a polymer or a polymer blend that has properties similar to those of vulcanized rubber at a use temperature of the grommet 1 and can be molded or remolded at a high temperature similarly to a thermoplastic resin. The thermoplastic elastomer is not particularly limited, and an amide-based thermoplastic elastomer (TPA), an ester-based thermoplastic elastomer (TPC), an olefin-based thermoplastic elastomer (TPO), a styrene-based thermoplastic elastomer (TPS), a urethane-based thermoplastic elastomer (TPU), a thermoplastic rubber crosslinked body (TPV), and other thermoplastic elastomers (TPZ) can be used. Those thermoplastic elastomers may be used alone or two or more thereof may be used in combination.

The olefin-based thermoplastic elastomer (TPO) is composed of a blend of a polyolefin and general rubber, and a rubber phase of the blend has no crosslinking point or substantially no crosslinking point. Examples of the polyolefin used in the olefin-based thermoplastic elastomer (TPO) include a homopolymer of an α-olefin such as ethylene, propylene, 1-butene, 1-pentene, 1-hexene, 4-methyl-1-pentene, 1-octene, and 1-decene, a copolymer of two or more kinds thereof, and the like. Specifically, a polypropylene-based resin, a polyethylene-based resin, and the like can be used. Examples of the rubber used in the olefin-based thermoplastic elastomer (TPO) include natural rubber (NR), isoprene rubber (IR), butadiene rubber (BR), styrene-butadiene copolymer rubber (SBR), acrylonitrile-butadiene copolymer rubber (NBR), chloroprene rubber (CR), butyl rubber (IIR), ethylene-propylene rubber (EPM), ethylene-propylene-diene rubber (EPDM), and the like.

The thermoplastic rubber crosslinked body (TPV) is a blend of a thermoplastic resin and general rubber, and the rubber is crosslinked by dynamic vulcanization in a blending or kneading process. As the thermoplastic elastomer of the present embodiment, a blend of a thermoplastic resin and crosslinked rubber is preferred because a grommet having good oil resistance can be obtained. However, the rubber is not necessarily required to be crosslinked by dynamic vulcanization.

Examples of the thermoplastic resin used in the thermoplastic rubber crosslinked body (TPV) include an amide-based resin, an ester-based resin, an olefin-based resin, a styrene-based resin, a urethane-based resin, and the like. The rubber used in the thermoplastic rubber crosslinked body (TPV) is not particularly limited, and examples thereof include natural rubber (NR), isoprene rubber (IR), butadiene rubber (BR), styrene-butadiene copolymer rubber (SBR), acrylonitrile-butadiene copolymer rubber (NBR), chloroprene rubber (CR), butyl rubber (IIR), ethylene-propylene rubber (EPM), ethylene-propylene-diene rubber (EPDM), and the like.

Note that the grommet 1 contains the thermoplastic elastomer as a main component, but may contain an additive other than the thermoplastic elastomer. Such an additive is not particularly limited, and examples thereof include a softener, a heat stabilizer, an antioxidant, a light stabilizer, an ultraviolet light absorber, a crosslinking agent, a crosslinking aid, an inorganic filler, a flame retardant, a lubricant, a colorant, and the like.

In the grommet 1, the diameter of the grommet main body 10 is not particularly limited, and may be, for example, 50 mm to 120 mm. When the diameter of the grommet main body 10 falls within this range, and the curvature radius R of the first corner portion 135 is 0.5 mm or more, generation of a crack in the panel fitting portion 13 can be suppressed more. Note that the diameter of the grommet main body 10 refers to a distance between one outer peripheral surface 10a and the other outer peripheral surface 10a of the grommet main body 10 in the cross-section along the center axis C.

As described above, the grommet 1 of the present embodiment includes the grommet main body 10 that is fitted into the through hole 101 provided in the attachment panel 100. The panel fitting portion 13 is provided integrally with the grommet main body 10. The panel fitting portion 13 is provided at the outer peripheral edge of the grommet main body 10, extends to the radially outer side of the grommet main body 10, and is fitted with the attachment panel 100. The grommet main body 10 and the panel fitting portion 13 contain the thermoplastic elastomer as a main component. The panel fitting portion 13 includes the first abutting portion 131 that is formed annularly and abuts against the one side surface 1001 of the peripheral edge of the through hole 101, the second abutting portion 132 that is formed annularly, faces the first abutting portion 131, and abuts against the other side surface 1002 of the peripheral edge of the through hole 101, the fitting groove 133 that is formed annularly, is provided between the first abutting portion 131 and the second abutting portion 132, and is fitted with the attachment panel 100. In the fitting groove 133, the curvature radius R of the corner portion (first corner portion) 135 formed between the outer peripheral surface 10a of the grommet main body 10 and the inner side surface 1312 of the first abutting portion 131 is 0.5 mm or more.

In the grommet 1, the curvature radius R of the first corner portion 135 in the fitting groove 133 of the panel fitting portion 13 is increased, and hence the load applied to the panel fitting portion 13 is dispersed. Thus, a possibility that a crack is generated in the panel fitting portion 13 is reduced, and the functions such as watertightness, dustproofing, and sound insulation can be maintained over a long period. Further, a flexible thermoplastic elastomer can be applied to the grommet 1, and hence a range of materials that can be used for the grommet 1 can be broadened. Furthermore, by switching a material of the grommet 1 to the thermoplastic elastomer, recyclability of the grommet 1 is improved, which can contribute to reduction in carbon dioxide.

Here, the specific gravity of the ethylene-propylene-diene rubber (EPDM) is approximately 1.2, whereas the specific gravity of the thermoplastic elastomer is approximately 0.9. Thus, the specific gravity of the thermoplastic elastomer is smaller than that of the thermosetting elastomer, an amount of material used for the grommet 1 is reduced when the thermoplastic elastomer is used. As a result, this can contribute to reduction in carbon dioxide.

In the grommet 1, the curvature radius R of the corner portion (first corner portion) 135 may be 0.5 mm to 1.0 mm. By setting the curvature radius R of the first corner portion 135 within such a range, generation of a crack at the time of fitting can be further suppressed even when the thermoplastic elastomer is used.

In the grommet 1, the outer peripheral edge 1311 of the first abutting portion 131 may be positioned on the radially outer side with respect to the outer peripheral edge 1321 of the second abutting portion 132. In the grommet 1, the curvature radius R of the first corner portion 135 positioned at the base end portion of the first abutting portion 131 is increased. Thus, even when the outer peripheral edge 1311 of the first abutting portion 131 is positioned on the radially outer side with respect to the outer peripheral edge 1321 of the second abutting portion 132, the load applied to the base end portion of the first abutting portion 131 is reduced, and generation of a crack in the first corner portion 135 can be suppressed.

The panel fitting portion 13 in the grommet 1 may further include the projection 134 that protrudes to the radially outer side of the grommet main body 10 in the fitting groove 133, is formed annularly, and abuts against the peripheral end of the through hole 101. Further, the corner portion (first corner portion) 135 may be positioned between the projection 134 and the first abutting portion 131. By providing the projection 134 to the panel fitting portion 1, the projection 134 abuts against the peripheral end of the through hole 101, is elastically deformed, and supports the peripheral end of the through hole 101. Thus, the functions of the grommet 1, such as such as watertightness, dustproofing, and sound insulation, can be enhanced more.

The grommet 1 may further include the bellows tubular portion (the second tubular portion 30) that is integrally connected to the grommet main body 10 on the first abutting portion 131 side in the axial direction X. Even when the second tubular portion 30 is bent, and the load is applied to the panel fitting portion 13, the load applied to the panel fitting portion 13 is dispersed because the curvature radius R of the first corner portion 135 in the fitting groove 133 is increased. Thus, a possibility that a crack is generated in the panel fitting portion 13 can be reduced.

The wire harness of the present embodiment includes the wiring material W having electroconductivity, and the grommet through which the wiring material W is inserted. Even when the thermoplastic elastomer is used, the gromet capable of suppressing generation of a crack at the time of fitting is used in the wire harness of the present embodiment, and hence the functions such as watertightness, dustproofing, and sound insulation can be maintained over a long period.

### EXAMPLES

The present embodiment is described below further in detail by Examples and Comparative Examples. However, the present embodiment is not limited to those examples.

### [Production of Grommet]

### Example 1

The grommet illustrated in FIGS. 1 to 5 was produced using the thermoplastic elastomer. Note that the curvature radius R of the first corner portion between the outer peripheral surface of the grommet main body and the inner surface of the first abutting portion was 0.5 mm. Further, the diameter of the grommet main body was 99.2 mm. Furthermore, the diameter of the distal end portion of the second tubular portion was 30 mm, and the thickness of the second tubular portion was 1.5 mm.

Note that, as the thermoplastic elastomer, AR1040 manufactured by ARONKASEI CO., LTD. was used. Further, the thermoplastic elastomer had a specific gravity of 0.9 as measured in accordance with Method A (Immersion Method) specified in JIS K 7112-1:2023 (Japanese Industrial Standards).

### Examples 2 to 4 and Comparative Examples 1 and 2

The grommet in each of the examples was produced similarly to Example 1, except that the curvature radius R of the first corner portion was set to a numerical value shown in Table 1.

### Reference Example

The grommet shown in FIGS. 1 to 5 was produced by using a thermosetting elastomer. Note that the curvature radius R of the first corner portion between the outer peripheral surface of the grommet main body and the inner surface of the first abutting portion was 0.2 mm. Further, the diameter of the grommet main body was 99.2 mm. Note that, in the thermosetting elastomer, EPDM having a Shore A hardness of 40 to 50 was used. Further, the thermosetting elastomer had a specific gravity of 1.2 as measured in accordance with Method A (Immersion Method) specified in JIS K 7112-1:2023.

TABLE 1

| | | Curvature | | |
|---|---|---|---|---|
| | | radius R | External | Specific |
| | Material type | (mm) | appearance | gravity |
| Comparative | Thermoplastic elastomer | 0.2 | Fail | 0.9 |
| Example 1 | | | | |
| Comparative | Thermoplastic elastomer | 0.3 | Fail | 0.9 |
| Example 2 | | | | |
| Example 1 | Thermoplastic elastomer | 0.5 | Pass | 0.9 |
| Example 2 | Thermoplastic elastomer | 0.7 | Pass | 0.9 |
| Example 3 | Thermoplastic elastomer | 0.8 | Pass | 0.9 |
| Example 4 | Thermoplastic elastomer | 1.0 | Pass | 0.9 |
| Reference | EPDM | 0.2 | Pass | 1.2 |
| Example | | | | |

### [Durability Test]

First, as the attachment panel, a metal plate having a through hole with a diameter of 83.2 mm and a thickness of 0.9 mm was prepared. Next, after the grommet of each of the examples was fitted into the through hole, the attachment panel to which the grommet was fitted was immersed in a constant-temperature bath at 85 degrees Celsius, and was left for 72 hours. Then, after the attachment panel to which the grommet was fitted was taken out from the constant-temperature bath, the grommet was removed from the through hole. Further, as a result of visually observing the removed grommet, a case where no generation of a crack was observed in the panel fitting portion was evaluated as “pass”, and a case where generation of a crack was observed in the panel fitting portion was evaluated as “fail”. The evaluation results of the grommets of the respective examples are collectively shown in Table 1.

From Table 1, it can be understood that, even in a case where the thermoplastic elastomer was used as a main component, when the curvature radius R of the first corner portion was 0.5 mm or more, no crack was generated in the panel fitting portion. In contrast, when the thermoplastic elastomer was used as a main component, and the curvature radius R of the first corner portion was 0.3 mm or less, a crack was generated in the panel fitting portion. Thus, it can be understood that, when the thermoplastic elastomer is used, generation of a crack in the grommet can be suppressed, and watertightness can be maintained in a high state by setting the curvature radius R of the first corner portion to 0.5 mm or more.

Note that, as shown in the reference example, in the grommet containing EPDM, which is a thermosetting elastomer, as a main component, although the curvature radius R of the first corner portion was 0.2 mm, generation of a crack was suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A grommet comprising:
a grommet main body that is fitted into a through hole provided in an attachment panel, wherein
a panel fitting portion is provided integrally with the grommet main body, the panel fitting portion being provided at an outer peripheral edge of the grommet main body, extending to a radially outer side of the grommet main body, and being fitted with the attachment panel,
the grommet main body and the panel fitting portion contain a thermoplastic elastomer as a main component,
the panel fitting portion includes:
a first abutting portion that is formed annularly and abuts against one side surface of a peripheral edge of the through hole;
a second abutting portion that is formed annularly, faces the first abutting portion, and abuts against the other side surface of the peripheral edge of the through hole; and
a fitting groove that is formed annularly, is provided between the first abutting portion and the second abutting portion, and is fitted with the attachment panel, and
in the fitting groove, a curvature radius of a corner portion formed between an outer peripheral surface of the grommet main body and an inner side surface of the first abutting portion is 0.5 mm or more.

2. The grommet according to claim 1, wherein
the curvature radius of the corner portion is 0.5 mm to 1.0 mm.

3. The grommet according to claim 1, wherein
an outer peripheral edge of the first abutting portion is positioned on the radially outer side with respect to an outer peripheral edge of the second abutting portion.

4. The grommet according to claim 1, wherein
the panel fitting portion further includes a projection that is provided in the fitting groove, protrudes toward the radially outer side of the grommet main body, is formed annularly, and abuts against a peripheral end of the through hole, and
the corner portion is positioned between the projection and the first abutting portion.

5. A wire harness comprising:
a wiring material having conductivity; and
the grommet according to claim 1, through which the wiring material is inserted.
